(19) United States
(12) Patent Application Publication
(10) Pub. No.: US 2022/0164093 A1
(43) Pub. Date: May 26, 2022

(54) ELECTRONIC DEVICE WITH EXPANDABLE DISPLAY

(71) Applicant: Samsung Electronics Co., Ltd., Gyeonggi-do (KR)

(72) Inventors: Jooyoung KANG, Gyeonggi-do (KR); Youngseong KIM, Gyeonggi-do (KR); Gyeongtae PARK, Gyeonggi-do (KR); Yangsoo CHOI, Gyeonggi-do (KR); Sungmin HONG, Gyeonggi-do (KR); Hyunju HONG, Gyeonggi-do (KR)

(21) Appl. No.: 17/550,017

(22) Filed: Dec. 14, 2021

Related U.S. Application Data
(63) Continuation of application No. PCT/KR2021/015649, filed on Nov. 2, 2021.

(30) Foreign Application Priority Data
Nov. 6, 2020 (KR) 10-2020-0148105
Dec. 3, 2020 (KR) 10-2020-0167860

(51) Int. Cl. G06F 3/04845; G06F 3/04842; G06F 3/04817; G06F 3/14; G06F 1/16

(52) U.S. Cl. CPC G06F 3/04845; G06F 3/04842; G06F 3/04817; G06F 3/016; G06F 1/1652; G06F 2203/04803; G06F 3/14

(57) ABSTRACT

A portable electronic device may include: a slidable housing including a first housing and a second housing coupled to the first housing to be slidable with respect to the first housing; a roller unit; a flexible display including a first display area disposed adjacent to the first housing and a second display area disposed in an inner space of the portable electronic device while surrounding the roller unit; a processor connected to the display; and a memory connected to the processor, wherein the memory stores instructions which, when executed, cause the processor to: when a state of the portable electronic device is a first state in which the second display area is disposed in the inner space, determine the first display area as an active area in which visual information is to be displayed, when the state of the portable electronic device is a second state in which the second display area is exposed to the outside, determine, as the active area, an entire area of the display including the first display area and the second display area, display first visual information and a first preview in the active area when the portable electronic device is in the first state, and display second visual information in the active area when the portable electronic device is in the second state. The first preview may be a graphic element for identifying the second visual information. In addition, various embodiments are possible.

### CROSS-REFERENCE TO RELATED APPLICATION(S)

This application is a continuation of International Application No. PCT/KR2021/015649, filed on Nov. 2, 2021 which claims priority to Korean Patent Application No. 10-2020-0148105 filed on Nov. 6, 2020 and No. 10-2020-0167860 filed on Dec. 3, 2020 in the Korean Intellectual Property Office, the disclosure of which is incorporated by reference herein in its entirety.

### TECHNICAL FIELD

Certain embodiments relate to an electronic device having a structure such that an active area on a display thereof, in which visual information is to be display, can be changed.

### BACKGROUND ART

An electronic device can have an expandable display. For example, when the display is expanded, an active area on the display, in which visual information is to be displayed, may be expanded from a partial area of the display to the entire area of the display. The electronic device can have an active display area of one size when the display is not expanded. When the display is expanded, an additional display area is added, thus resulting in a larger display area.

### SUMMARY

An electronic device may change the configuration of the screen to be displayed (visual information) as the size of the active area of the display is expanded or reduced.

The screen can be configured to be displayed within an active area of the display. When the size of the active area is changed, the content and objects of the screen are changed to accommodate the changed size. However, this screen change may unexpectedly cause a displeasing user experience.

In various embodiments, a portable electronic device may include: a slidable housing including a first housing and a second housing coupled to the first housing to be slidable with respect to the first housing; a flexible display including a first display area disposed adjacent to the first housing and a second display area disposed in an inner space of the portable electronic device; a processor connected to the display; and a memory connected to the processor, wherein the memory stores instructions which, when executed, cause the processor to: when a state of the portable electronic device is a first state in which the second display area is disposed in the inner space, determine the first display area as an active area in which visual information is to be displayed, when the state of the portable electronic device is a second state in which the second display area is exposed to the outside as the second housing slides, determine, as the active area, an entire area of the display including the first display area and the second display area, display first visual information and a first preview in the active area when the portable electronic device is in the first state, and display second visual information in the active area when the portable electronic device is in the second state. The first preview may be a graphic element for identifying the second visual information.

In various embodiments, a portable electronic device may include: a slidable housing including a first housing and a second housing coupled to the first housing to be slidable with respect to the first housing; a flexible display including a first display area disposed adjacent to the first housing and a second display area disposed in an inner space of the portable electronic device, and configured to respond to a user input; a state change module configured to change a state of the portable electronic device from a first state in which the second display area is disposed in the inner space to a second state in which the second display area is exposed to the outside as the second housing slides, or change the state of the portable electronic device from the second state to the first state; a processor connected to the display and the state change module; and a memory connected to the processor, wherein the memory stores instructions which, when executed, cause the processor to: when the portable electronic device is in the first state, determine the first display area as an active area in which visual information is to be displayed, when the portable electronic device is in the second state, determine an entire area of the display including the first display area and the second display area as the active area, display a handler in the active area, receive, on the handler, a user input from the display, and drive the state change module according to the user input so as to change the state of the portable electronic device from the first state to the second state or vice versa.

In certain embodiments, an electronic device may be configured to be able to notify the user in advance that the configuration of the screen may be changed when the active area is changed (the size thereof is expanded or reduced). The electronic device may be configured to be able to change the active area (expand or reduce the size of the active area) by using a handler displayed on the display.

Certain embodiments may provide an electronic device configured to inform the user in advance of a change in visual information resulting from expansion or reduction of a display. In addition, certain embodiments may provide an electronic device configured such that a handler recalled to a display can be used to expand or reduce the display. Various other advantageous effects inferred directly or indirectly through this document may be provided.

### BRIEF DESCRIPTION OF DRAWINGS

FIG. 1 is a block diagram of an electronic device in a network environment, according to certain embodiments;

FIGS. 2A and 2B illustrate a portable electronic device having a slidable housing structure, according to an embodiment;

FIGS. 3A and 3B illustrate a portable electronic device having a slidable housing structure, according to an embodiment;

FIG. 4 is an electrical block configuration of an electronic device configured to support a user interface (UI) for interaction with a user in relation to a state change (or a size change of an active area) of the electronic device, according to certain embodiments;

FIGS. 5A and 5B are diagrams illustrating an operation of displaying a preview related to a size of a background element, according to certain embodiments, FIGS. 6A and 6B are diagrams illustrating an operation of displaying a preview related to a layout of a UI element, according to certain embodiments, and FIGS. 7A and 7B are diagrams illustrating an operation of displaying a preview related to a configuration of a UI element, according to certain embodiments;

FIG. 8 is a diagram illustrating an operation of providing a preview when entering an application, according to certain embodiments;

FIG. 9 is a diagram illustrating an operation of providing a preview during a state change, according to certain embodiments;

FIGS. 10A, 10B, and 10C are diagrams illustrating an operation of visually notifying a user that visual information may be changed according to a state change of an electronic device, according to certain embodiments;

FIGS. 11, 12, 13, and 14 are diagrams illustrating certain embodiments of an operation of changing a state of an electronic device by using a handler, according to certain embodiments;

FIGS. 15, 16, 17, and 18 are diagrams illustrating certain embodiments of an operation of recalling a handler to a display, according to certain embodiments;

FIGS. 19 and 20 are diagrams illustrating certain embodiments of an operation of ending display of a handler, according to certain embodiments;

FIG. 21 is a diagram illustrating an operation of moving, on a screen, a button for recalling a handler, according to certain embodiments;

FIG. 22 is a diagram illustrating an operation of moving a handler on a screen, according to certain embodiments; and

FIG. 23 is a diagram for describing an operation of configuring attributes of a handler, according to certain embodiments.

### DETAILED DESCRIPTION

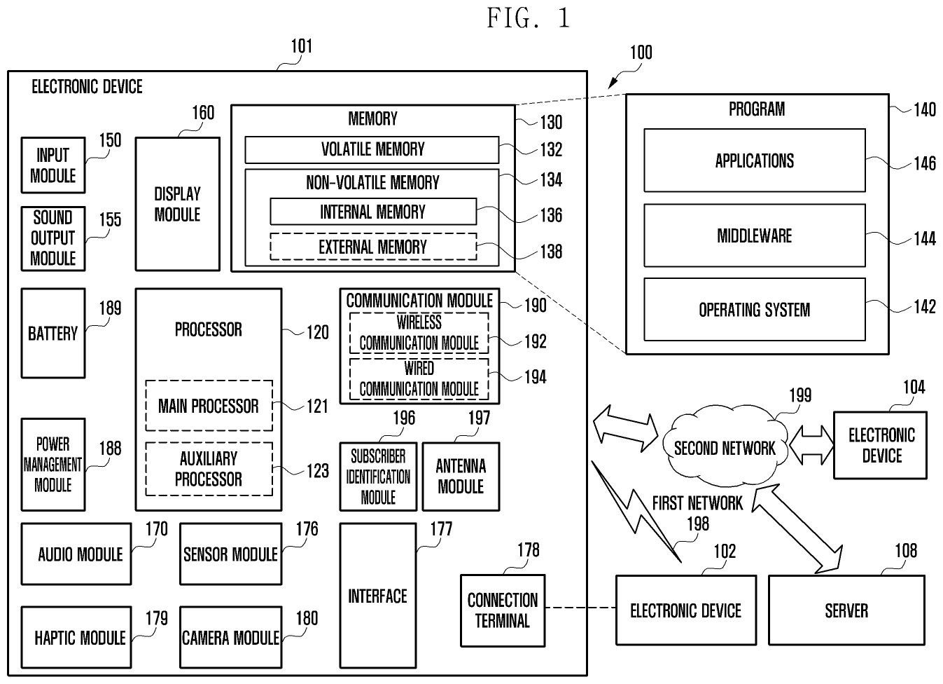

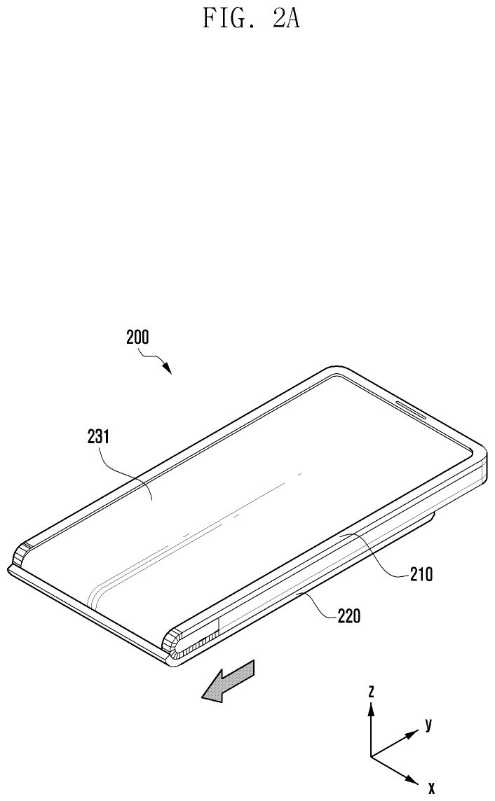

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with certain embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

The electronic device 101 may display a screen on an active area of the display module 160. when the size of the active area is changed, contents of the screen may be reconfigured accordingly. The reconfiguration can be confusing to the user when performed unexpectedly.

Various housing structures may be applied to an electronic device 101. For example, the electronic device 101 may include a foldable housing which is divided into two housings with respect to a folding axis. A first display area of a display (e.g., a flexible display) may be disposed in a first housing, and a second display area of the display may be disposed in a second housing. The foldable housing may be implemented in an in-folding manner in which the first display area and the second display area face each other when a portable electronic device is in a folded state. Alternatively, the foldable housing may be implemented in an out-folding manner in which a first part and a second part face in the opposite direction when the portable electronic device is in the folded state. For another example, the electronic device 101 may include a slidable (or rollable) housing that allows at least a portion of the flexible display to be wound around or unwound from a roller unit (or a rotating assembly) disposed in an inner space of the electronic device 101. Hereinafter, a surface on which the display is disposed (e.g., a surface on which a display area is visually exposed) is defined as a front surface of the electronic device. In addition, the opposite surface of the front surface is defined as a rear surface of the electronic device. In addition, a surface surrounding the space between the front surface and the rear surface is defined as a lateral surface of the electronic device. The term “state” may refer to a structural form, contour, or shape of the electronic device (or the display).

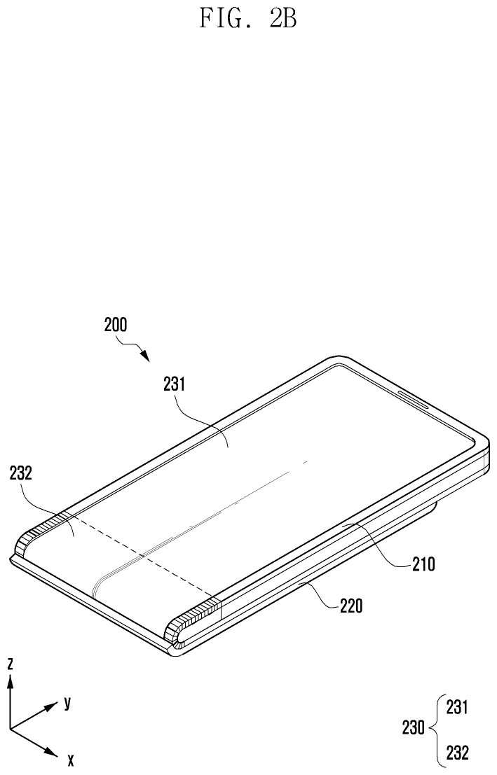

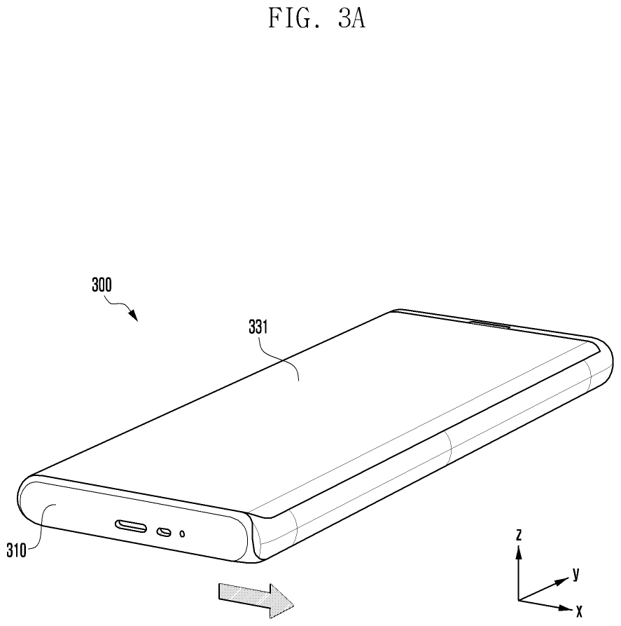

FIGS. 2A and 2B illustrate a portable electronic device 200 having a slidable housing structure, according to an embodiment. Referring to FIGS. 2A and 2B, the portable electronic device 200 (e.g., the electronic device 101 of FIG. 1) may include a first housing 210, a second housing 220, a roller unit (not shown), and a flexible or foldable display 230 disposed in a space formed by the slidable housings 210 and 220.

The second housing 220 may be coupled to the first housing 210 to be slidable. The roller unit may be disposed in an inner space of the second housing 220. The display 230 may include a first display area 231 disposed adjacent to the first housing 210, and a second display area 232 disposed in the inner space while surrounding the roller unit. When the second housing 220 slides toward the first housing 210, the second display area 232 may move to the inside of the second housing 220 and be wound around the roller unit. When the second housing 220 slides in a direction away from the first housing 210 (e.g., a −y-axis direction as shown in FIG. 2A), the second display area 232 may be unwound from a rotating assembly and exposed to the outside.

According to an embodiment, a state of the electronic device 200 may be defined based on a rotation angle of the roller unit (e.g., an angle at which the roller unit rotates in a direction (e.g., clockwise) in which the display 230 is unwound from the roller unit). For example, when the rotation angle of the roller unit exceeds a first threshold value, the state of the electronic device 200 may be defined as a first state (or, normal state or slide-in state) in which only the first display area 231 of the display 230 is exposed (or the second display area 232 is disposed in the inner space). When the rotation angle of the roller unit exceeds a second threshold value which is larger than the first threshold value, the state of the electronic device 200 may be defined as a second state (or, extended state or slide-out state) in which an entire area (e.g., the first display area 231 and the second display area 232) of the display 230 is exposed. The state in which the second display area 232 is partially exposed from the roller unit (or partially wound around the roller unit) may be defined as a third state (or intermediate state) in this document.

According to another embodiment, the state of the electronic device 200 may be defined based on a curvature (degree of bending) of a designated part in the display 230. For example, when a curvature of the second display area 232 corresponds to a value (or within a range) indicating concavity (or convexity), the state of the electronic device 200 may be defined as the first state. When the curvature of the second display area 232 corresponds to a value (or within a range) indicating flatness, the state of the electronic device 200 may be defined as the second state.

Based on the state of the electronic device 200, an active area in which visual information (e.g., an application execution screen) is to be displayed on the display 230 may be determined. For example, when the electronic device 200 is in the first state, the active area may be determined as the first display area 231, and thus the visual information may be displayed in the first display area 231. When the electronic device 200 is in the second state, the active area may be determined as the entire area (e.g., the first display area 231 and the second display area 232) of the display 230, and thus the visual information may be displayed in the entire area.

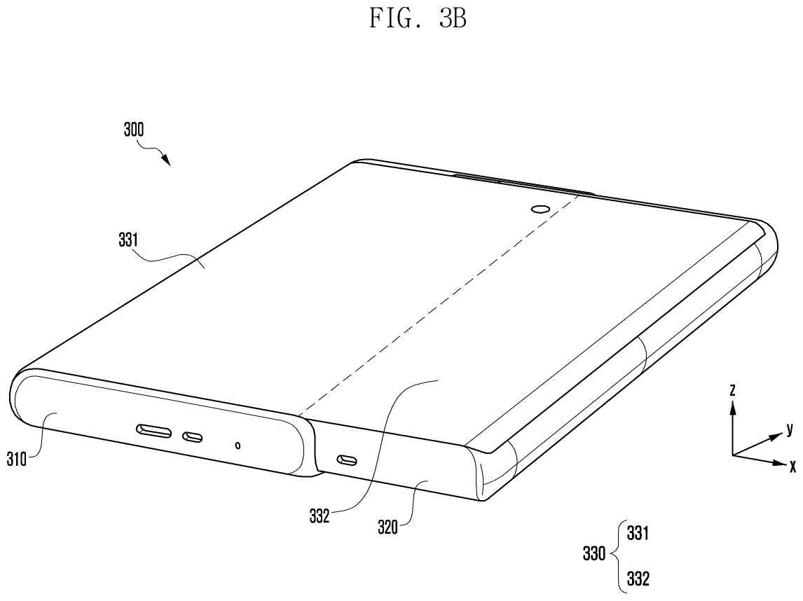

FIGS. 3A and 3B illustrate a portable electronic device 300 having a slidable housing structure, according to an embodiment. In the description of the portable electronic device 300, a configuration, a function, and/or a structure overlapping those of FIG. 2 will be briefly described or omitted. Referring to FIGS. 3A and 3B, the portable electronic device 300 (e.g., the electronic device 101 of FIG. 1) may include a first housing 310, a second housing 320, a roller unit (not shown), and a flexible or foldable display 330 disposed in a space formed by the slidable housings 310 and 320. The display 330 may include a first display area 331 disposed adjacent to the first housing 310, and a second display area 332 disposed in the inner space while surrounding the roller unit. When the second housing 320 slides in a direction away from the first housing 310 (e.g., an x-axis direction as shown in FIG. 3A), the second display area 332 may be unwound from the roller unit and exposed to the outside.

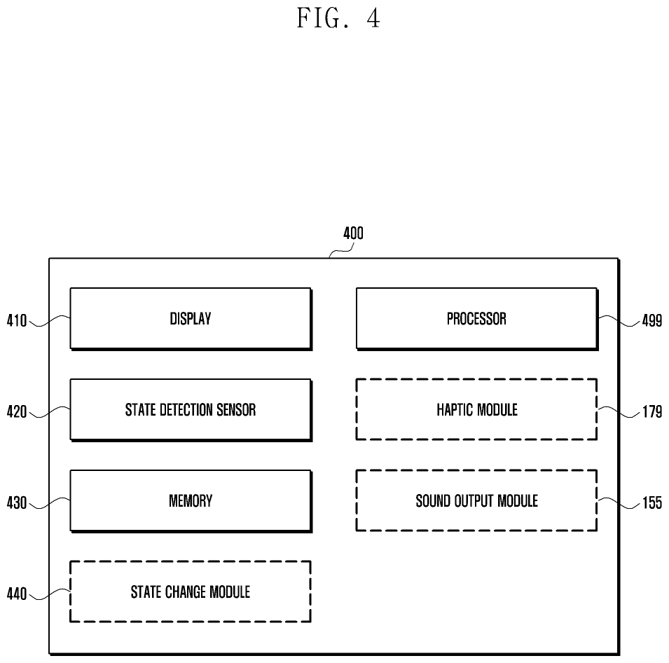

FIG. 4 is an electrical block configuration of an electronic device 400 configured to support a user interface (UI) for interaction with a user in relation to a state change (or a size change of an active area) of the electronic device, according to certain embodiments. Referring to FIG. 4, the electronic device 400 (e.g., the portable electronic device 200 of FIG. 2 or the portable electronic device 300 of FIG. 3) may include a display 410 (e.g., the display module 160 of FIG. 1), a state detection sensor 420, a memory 430, and a processor 499.

The display 410 may include a first display area 411 and a second display area 412. As previously described with reference to FIG. 2, in the display 410, an active area in which visual information is to be displayed may be determined as the first display area 411 or an entire area (e.g., the first display area 411 and second display area 412) of the display 410, according to a state of the electronic device 400.

The state detection sensor 420 (e.g., the sensor module 176 of FIG. 1) may generate data used to recognize the state (e.g., the first state or the second state) of the electronic device 400. For example, the state detection sensor 420 may include a sensor (e.g., an encoder or a hall sensor) which is attached to the roller unit to generate and output data corresponding to a rotation angle of the roller unit. For another example, the state detection sensor 420 may include a sensor (e.g., a pressure sensor) which is disposed in a designated part (e.g., the second display area 232 of FIG. 2 or the second display area 332 of FIG. 3) of the display 410 to generate data corresponding to a curvature of the corresponding part.

The memory 430 may store visual information to be displayed in the active area. For example, the visual information may include a background element and a user interface (UI) element (or a user experience (UX) element and a foreground element). The UI element is a graphic element which allows the electronic device 400 to interact with a user, and may include, for example, a video, image, text, thumbnail, emoticon, icon, keypad, button, or menu. The processor 499 may execute a function operatively connected to the UI element, in response to a user's touch input on the UI element. The background element is a graphic element which is not related to the interaction between the electronic device 400 and a user and is not connected to a specific function, and may include, for example, a background image or text.

The visual information may be classified into first visual information to be displayed when the electronic device 400 is in the first state and second visual information to be displayed when the electronic device 400 is in the second state. The first visual information may be different from the second visual information in an amount, attribute, layout, or configuration of information to be displayed to a user. For example, the second visual information may have a content amount (e.g., text amount, number of images, or number of pages) greater than that of the first visual information. The attribute may include size, color, or brightness. For example, when the electronic device is changed from the first state to the second state, the size of a background element and/or a foreground element may be enlarged, and when the electronic device is switched vice versa, the size of the corresponding element may be reduced. As the state is changed, a layout of an UI element may be changed. For example, as the electronic device is changed from the first state to the second state, for example, a position of the UI element may be changed from the first display area to the second display area. The second visual information may have a UI element different from the UI element configured in the first visual information. For example, when the electronic device is changed from the first state to the second state, a new UI element not included in the first visual information may be included in the second visual information to be displayed in the active area. For another example, when the electronic device is changed from the first state to the second state, a second UI element may be displayed in the active area instead of a first UI element.

The memory 430 may store configuration information used to configure visual information to be displayed in the active area. For example, the configuration information may include first configuration information for configuring visual information when the electronic device 400 is in the first state, and second configuration information for configuring visual information when the electronic device is in the second state. For example, when the electronic device 400 is in the first state, the processor 499 may configure visual information to be displayed in the active area as the first visual information by using the first configuration information. When the electronic device 400 is in the second state, the processor 499 may configure the visual information as the second visual information by using the second configuration information.

The memory 430 may store instructions which cause the processor 499 to perform an operation of notifying a user that visual information is also changed when the state of the electronic device 400 is changed.

According to an embodiment, the instructions may cause the processor 499 to: perform an operation of determining the first display area as the active area when the electronic device 400 is in the first state and, accordingly, displaying the first visual information and a first preview in the active area, or an operation of determining the entire area of the display 410 as the active area when the electronic device 400 is in the second state and, accordingly, displaying the second visual information and a second preview in the active area. When the electronic device 400 is changed from the first state to the second state, the first preview may be a graphic element which allows a user to recognize that the second visual information is displayed on the display 410 instead of the first visual information. When the electronic device 400 is changed from the second state to the first state, the second preview may be a graphic element which allows a user to recognize that the first visual information is displayed on the display 410 instead of the second visual information. For example, a preview may be a thumbnail image which is a reduction of the corresponding visual information. For another example, the preview may include an icon in which an element (e.g., amount, attribute, layout, or configuration of information) indicating the difference between the two pieces of visual information is shaped. For another example, the preview may include text indicating the difference between the two pieces of visual information.

According to an embodiment, the instructions may cause the processor 499 to: perform the operations of determining whether visual information, as an execution screen of an application to be displayed on the display 410, exists for each state of the electronic device 400, based on a file (e.g., a manifest file) used to execute the application, displaying, on the display 410, a preview corresponding to a state different from the visual information corresponding to a current state of the electronic device 400 when it is determined that the visual information exists for each state, and displaying the visual information on the display 410 without the preview when it is determined that the visual information does not exist for each state.

According to an embodiment, the instructions may cause the processor 499 to: perform an operation of ending the display of the preview when a specified time has elapsed from the time when the display of the preview is started.

According to an embodiment, the portable electronic device 400 may further include a haptic module 179. The instructions may cause the processor 499 to: perform an operation of notifying a user in advance that visual information may be changed according to a state change of the electronic device 400 by using the haptic module 179 as a tactile means other than a visual reminder using the display 410.

According to an embodiment, the portable electronic device 400 may further include a sound output module 155. The instructions may cause the processor 499 to: perform an operation of notifying a user in advance that visual information may be changed according to a state change of the electronic device 400 by using the sound output module 155 as an auditory means.

According to one embodiment, the instructions may cause the processor 499 to: perform the reminder by using a combination of two or more of visual, auditory, and tactile means.

According to an embodiment, the instructions may cause the processor 499 to: change the intensity, number of times, or rhythm of vibration of the tactile means according to the type of reminder. For example, Table 1 as a table related to a tactile reminder is stored in the memory 430, and the processor 499 may adjust the intensity and number of times of vibration of the tactile means with reference to Table 1.

TABLE 1

| | | | Configur- | Amount of |
|---|---|---|---|---|
| Vibration | Attribute | Layout | ation | content |
| Intensity | Weak | Strong | Strong | Weak |
| Number of | 1 | 2 | 3 | 2 |
| times | | | | |

According to an embodiment, the instructions may cause the processor 499 to: change sound volume, the number of times the sound is output, or a sound type of the auditory means according to the type of reminder. For example, Table 2 as a table related to an auditory reminder is stored in the memory 430, and the processor 499 may adjust the intensity, the number of times of output, and the type of sound with reference to Table 2.

TABLE 2

| | | | Configur- | Amount of |
|---|---|---|---|---|
| Sound | Attribute | Layout | ation | content |
| Intensity | Weak | Strong | Strong | Weak |
| Number of | 1 | 2 | 3 | 2 |
| times of output | | | | |
| Type | A | B | C | D |

The portable electronic device 400 may further include a state change module 440. The state change module 440 may include a motor which rotates the roller unit. The state change module 440 may rotate the roller unit according to the control of the processor 499 to change a state of the electronic device 400 from the first state to the second state or vice versa. The instructions may cause the processor 499 to: perform the operations of displaying, on the display 410, a handler for a state change of the electronic device 400 as a type of UI element, in response to a user input, receiving a touch input on the handler from the display 410, driving the state change module 440, based on the touch input, so as to change the state of the electronic device 400 from the first state to the second state or vice versa, and ending the display of the handler after the state change (or when the user input that has triggered the state change is released).

According to an embodiment, the instructions may cause the processor 499 to: perform the operations of receiving a touch input from the display 410, recognizing that the received touch input is a user input (e.g., a long press or a force touch) designated for recalling a handler, and displaying the handler on the display 410 in response to the recognition.

According to an embodiment, the instructions may cause the processor 499 to: perform the operations of recognizing a user input for recalling a handler from data received from the sensor module 176 (e.g., a grip sensor) or the input module 150 (e.g., a physical button placed on a lateral surface of the electronic device 400), and displaying the handler on the display 410 in response to the recognition.

According to an embodiment, the instructions may cause the processor 499 to: perform an operation of configuring a handler as the top layer among graphic elements. For example, when display positions of an execution screen and the handler overlap, the handler may be positioned on the execution screen. While an UI element in the execution screen is positioned under the handler, the processor 499 may be configured so as not to respond to a touch input on the UI element.

According to an embodiment, the instructions may cause the processor 499 to: perform an operation of adjusting the transparency of a handler such that a user can identify an UI element positioned under the handler.

The processor 499 (e.g., the processor 120 of FIG. 1) may be operatively connected to the display 410, the state detection sensor 420, and the memory 430.

The processor 499 may recognize a state of the electronic device 400 by using data received from the state detection sensor 420, and determine an active area in which visual information is to be displayed, based on the recognized state of the electronic device 400. For example, the processor 499 may determine the first display area 411 as the active area, based on recognition that the electronic device 400 is in the first state. The processor 499 may determine the entire area (e.g., the first display area 411 and second display area 412) of the display 410 as the active area, based on recognition that the electronic device 400 is in the second state. When it is recognized that the electronic device 400 is in the third state, the processor 499 may determine an exposed part in the second display area 412, based on a rotation angle of the roller unit, and determine the exposed part together with the first display area 411 as the active area.

The processor 499 may be configured to perform operations defined by the instructions stored in the memory 430. The operations of the processor 499 are described in detail below. Further, additional operations of the processor 499 are described below.

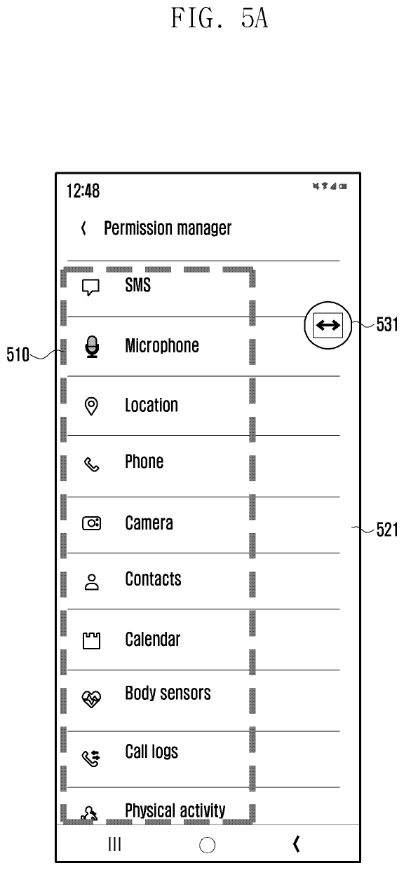

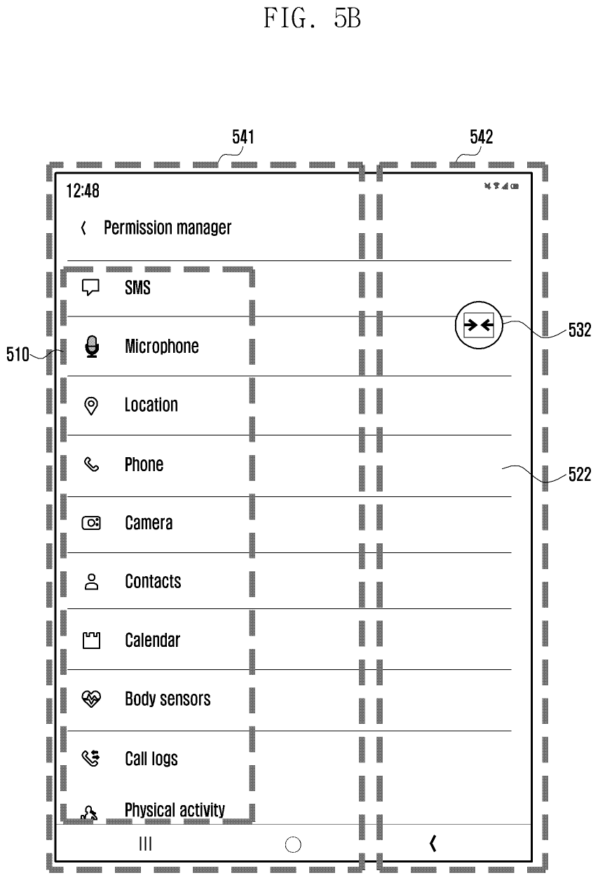

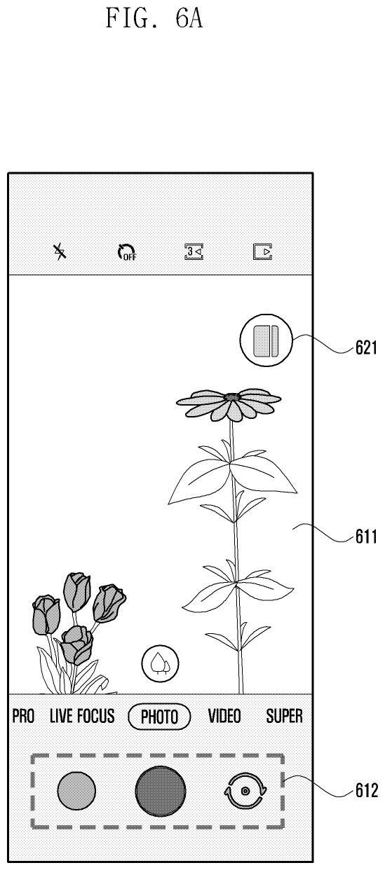

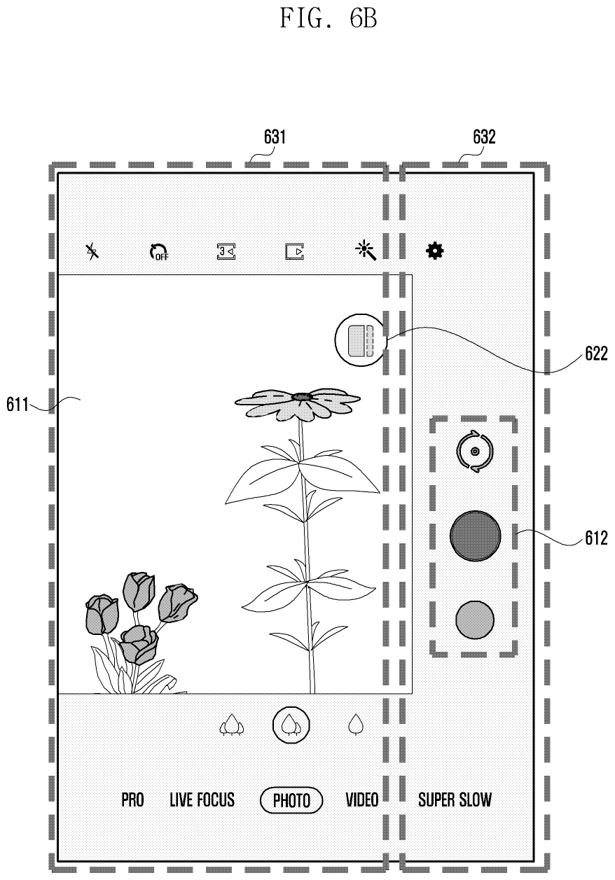

FIGS. 5A and 5B are diagrams illustrating an operation of displaying a preview related to a size of a background element. FIGS. 6A and 6B are diagrams illustrating an operation of displaying a preview related to a layout of a UI element. FIGS. 7A and 7B are diagrams illustrating an operation of displaying a preview related to a configuration of a UI element.

Referring to FIGS. 5A and 5B, the processor 499 may display, on the display 410, an execution screen of a permission manager for managing the permission of an application installed in the electronic device 400. The execution screen may include an application list 510 as a type of UI element. When the electronic device 400 is in the first state, the processor 499 may display the application list 510 on a first background element 521. In addition, when the electronic device 400 is in the first state, the processor 499 may display a first preview 531 (FIG. 5A) representing a second background element 522 on the first background element 521. When the electronic device 400 is in the second state, the processor 499 may display a second preview 532 (FIG. 5B) representing the first background element 521 on the second background element 522. The second background element 522 may be a graphic element, a size of which is expanded compared to that of the first background element 521. For example, as the state of the electronic device 400 is switched from the first state to the second state, an active area may be extended from a first display area 541 to an entire area (e.g., the first display area 541 and a second display area 542) of the display 410. The second background element 522 may be a graphic element extending from the first background element 521 as much as the size of the second display area 542.

Referring to FIGS. 6A and 6B, the processor 499 may display an execution screen of a camera application on the display 410. The execution screen may include an image 611 received from a camera (e.g., the camera module 180 of FIG. 1) and a menu 612 for controlling the camera, as a type of UI element. When the electronic device 400 is in the first state, the processor 499 may display, on the image 611, a first preview 621 (FIG. 6A) indicating that a layout of the execution screen is changed when the electronic device is changed to the second state. When the electronic device 400 is changed from the first state to the second state, the processor 499 may change the layout of the execution screen. For example, as the state of the electronic device 400 is switched from the first state to the second state, an active area may be extended from a first display area 631 to an entire area (e.g., the first display area 631 and a second display area 632) of the display 410. According to the extension, the processor 499 may change a display position of the menu 612 from the first display area 631 to the second display area 632 as shown in FIG. 6B. When the electronic device is changed to the first state (e.g., when the active area is reduced to the first display area 631), as shown in FIG. 6B, the processor 499 may display, on the image 611, a second preview 622 indicating that the layout of the execution screen is changed (e.g., the display position of the menu 612 is moved to the first display area 631).

Referring to FIGS. 7A and 7B, the processor 499 may display an execution screen of a call application on the display 410. When the electronic device 400 is in the first state, the processor 499 may display the execution screen including a keypad 710 and a call button 720 on the display 410. In addition, the processor 499 may display, on the display 410, a first preview 731 (FIG. 7A) indicating that a configuration of the execution screen is changed (e.g., an UI element is added to the execution screen) when the electronic device is changed to the second state. When the electronic device 400 is changed from the first state to the second state, the processor 499 may display, on the display 410, the execution screen further including a menu 740 (FIG. 7B) for changing a configuration of an UI element to be displayed on the display. For example, the menu 740 may include a first button 741 operatively connected with the keypad 710, a second button 742 connected with a recent call record, a third button 743 connected with contact information, or a fourth button 744 connected with a call service for a place around the electronic device 400. For example, when a touch input is generated on the second button 742, a recent call record may be displayed instead of the keypad 710. The processor 499 may display, in an active area, a second preview 732 (FIG. 7B) indicating that the configuration of the execution screen is changed (e.g., the menu 740 is omitted from the execution screen) when the electronic device is changed to the first state.

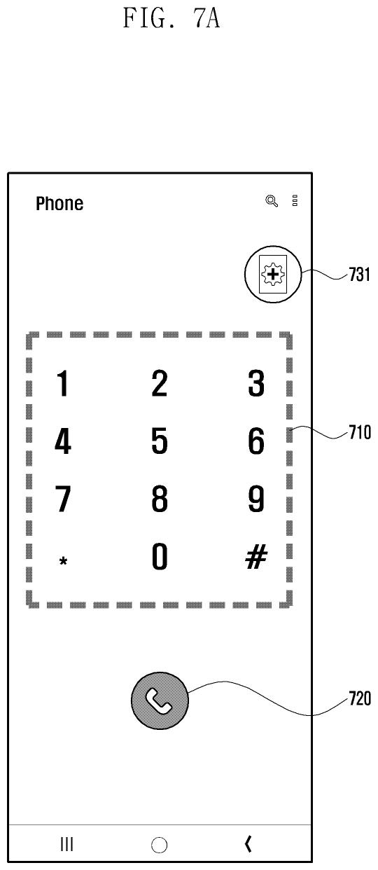

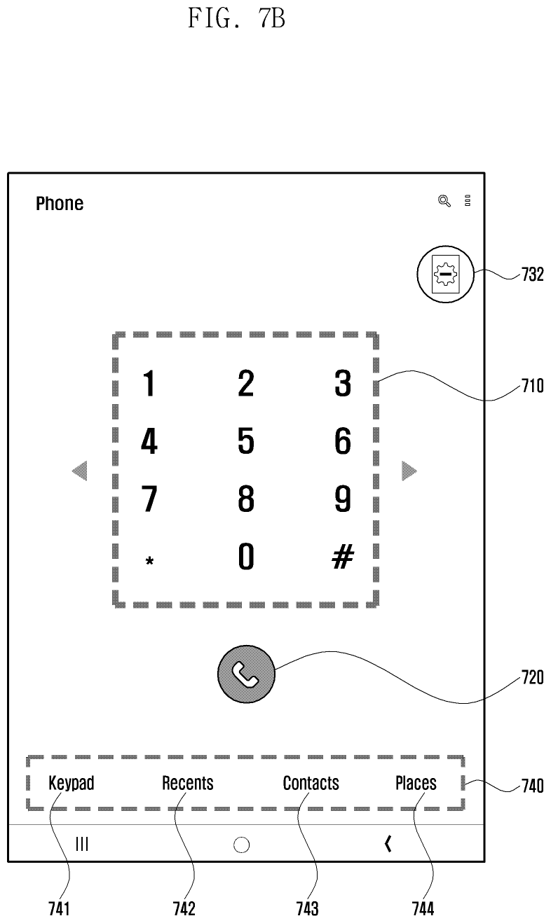

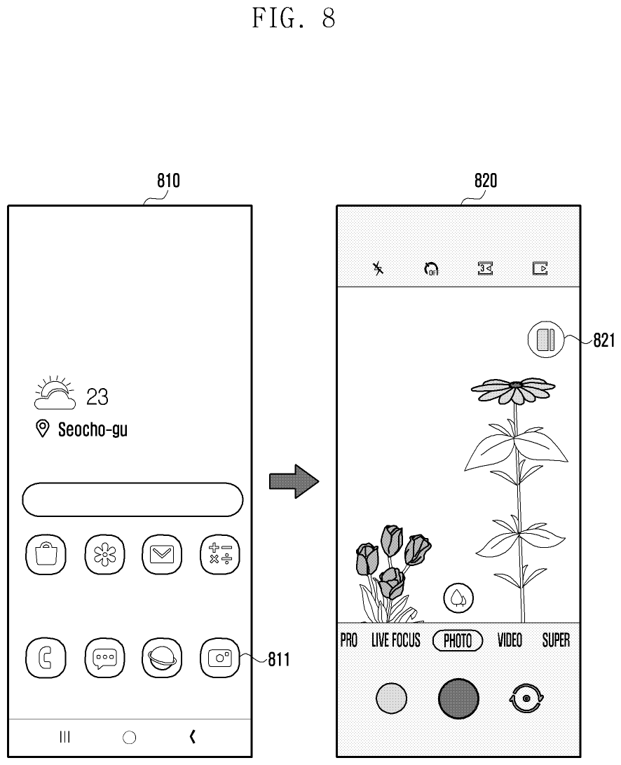

FIG. 8 is a diagram illustrating an operation of providing a preview when entering an application. Referring to FIG. 8, the processor 499 may display an execution screen 810 of a home application on the display 410. The execution screen 810 may include an icon corresponding to each application. The processor 499 may receive, from the display 410, a touch input on, for example, an icon 811 of a camera application among icons. In response to the reception of the touch input, the processor 499 may display an execution screen 820 of the camera application on the display 410. The processor 499 may determine whether the camera application exists for each state of the electronic device 400, based on a camera application file (e.g., a manifest file). When it is determined that the execution screen exists for each state, the processor 499 may display, on the display 410, the execution screen 820 corresponding to a current state (e.g., the first state) of the electronic device 400, and a preview 821 corresponding to a different state (e.g., the second state).

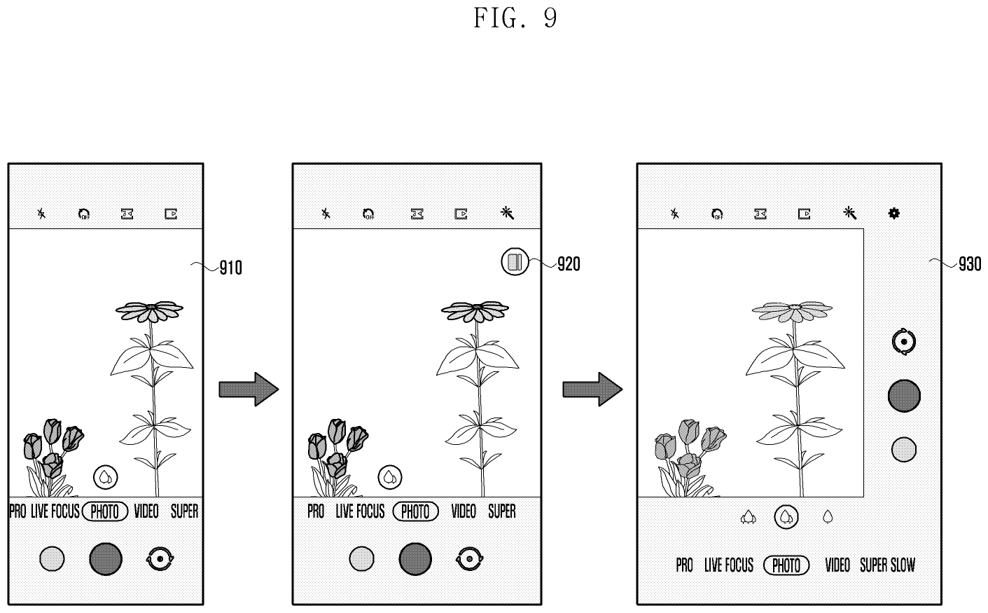

FIG. 9 is a diagram illustrating an operation of providing a preview during a state change. Referring to FIG. 9, when the electronic device 400 is in the first state, the processor 499 may display a first execution screen 910 corresponding to the first state on the display 410. While the electronic device 400 is changed from the first state to the second state, the processor 499 may display a first preview 920 indicating a second execution screen 930 on the display 410. When a state of the electronic device 400 is changed to the second state, the processor 499 may display the second execution screen 930 on the display 410 without the first preview 920. Although not shown, while the electronic device 400 is changed from the second state to the first state, the processor 499 may display a second preview indicating the first execution screen 910 on the display 410.

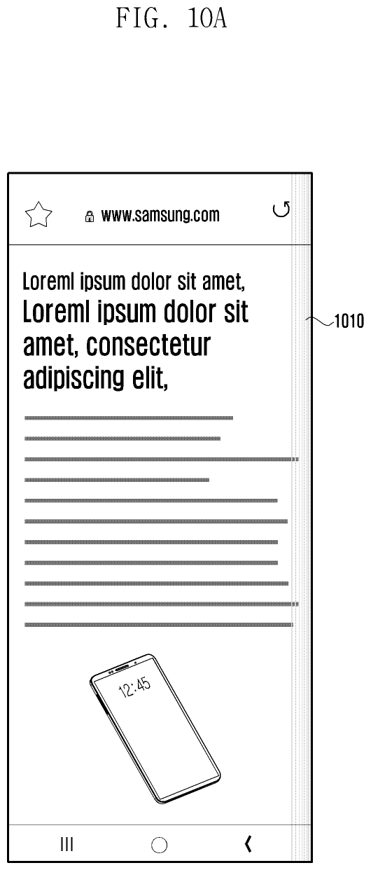

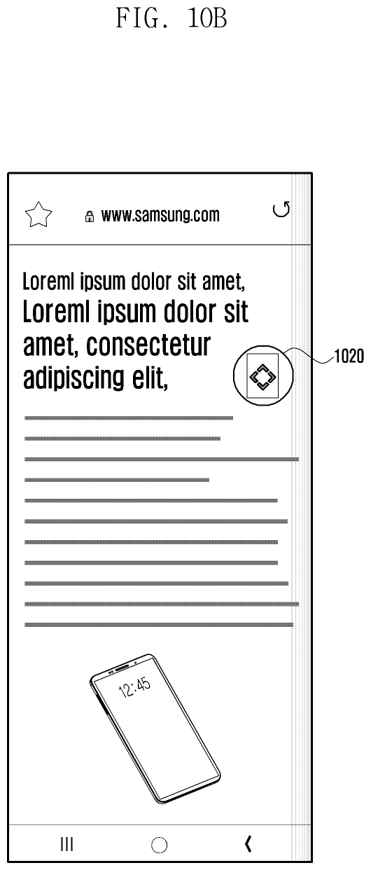

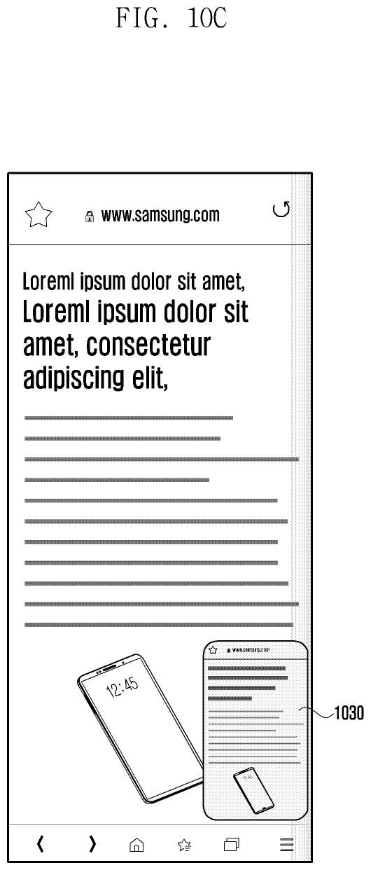

FIGS. 10A, 10B, and 10C are diagrams illustrating an operation of visually notifying a user that visual information may be changed according to a state change of an electronic device 400.

The processor 499 may display visual information (e.g., a web page) corresponding to a current state (e.g., the first state) of the electronic device 400 on the display 410 (e.g., the first display area 411). The processor 499 may display, on the display 410, a visual effect indicating that the visual information is also changed when a state of the electronic device is changed. For example, the processor 499 may display a visual effect 1010 (FIG. 10A) in an edge part of the first display area 411 adjacent to the second display area 412 hidden when the electronic device 400 is in the first state. For example, the visual effect 1010 may include a visual effect for changing attributes (e.g., brightness, color, and saturation) between an edge part and other parts in a background element of the visual information. For example, the visual effect 1010 may not be displayed when a display area is no longer changed. For example, the processor 499 may end the provision of the visual effect 1010 in a state in which a size of a screen is the minimum (e.g., the first state) and/or a state in which the size of the screen is the maximum (e.g., the second state).

The processor 499 may display, on the display 410 (e.g., the first display area 411), visual information (e.g., a web page) corresponding to the first state as the current state of the electronic device 400. The processor 499 may display, on the display 410, an icon 1020 (FIG. 10B) indicating that the visual information is also changed when a state of the electronic device is changed. For example, the icon 1020 may be an image representing that the amount of a web page to be displayed on the display 410 increases as a display area is expanded.

The processor 499 may display, on the display 410 (e.g., the first display area 411), first visual information (e.g., a web page) corresponding to the first state as the current state of the electronic device 400. The processor 499 may display, on the display 410, a thumbnail 1030 (FIG. 10C) which is a reduction of second visual information corresponding to a different state (e.g., the second state) of the electronic device 400.

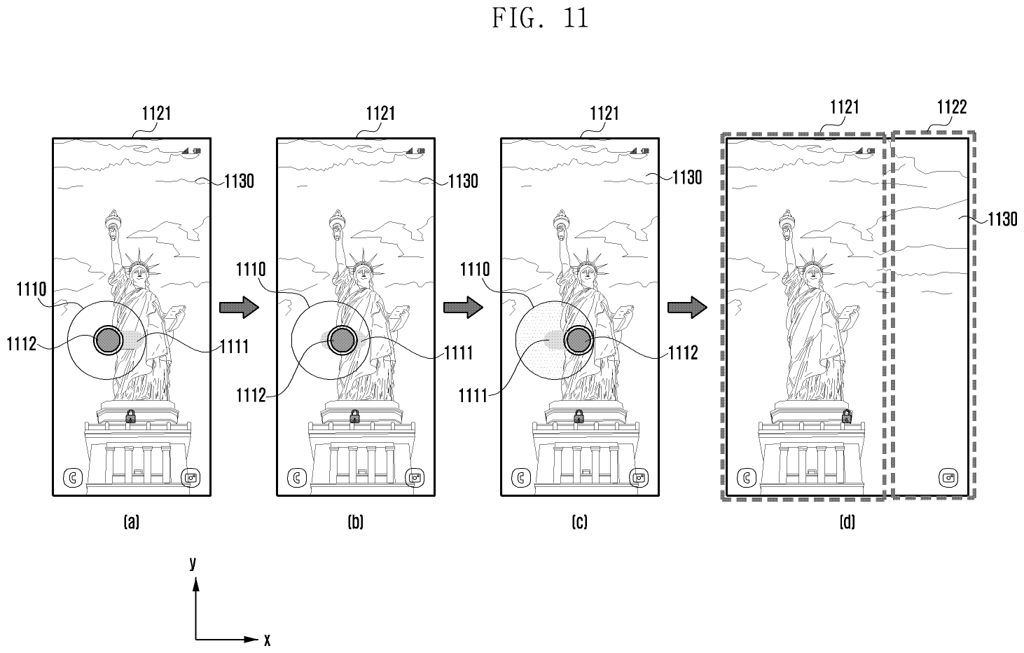

FIGS. 11, 12, 13, and 14 are diagrams illustrating certain embodiments of an operation of changing a state of an electronic device 400 by using a handler.

Referring to FIG. 11, the processor 499 may display a handler 1110 for a state change of the electronic device 400 on the display 410. For example, the processor 499 may include, in the handler 1110, a rail 1111 extending in a straight line parallel to an x-axis direction in which the display 410 is expanded, and display the rail 1111 on a lock screen 1130. The processor 499 may display a lever 1112 configured to move on the rail 1111 according to a user input. The processor 499 may display the lever 1112 at a position corresponding to a current state of the electronic device 400. The processor 499 may respond to a movement of the lever 1112 on the rail 1111 to change a state of the electronic device 400 from the first state to the second state or vice versa. For example, when the electronic device 400 is in the first state, the processor 499 may display the lever 1112 on the leftmost side (or a first position) of the rail 1111 as shown in (a) of FIG. 11. The processor 499 may move the lever 1112 to the right according to a right drag input to the lever 1112 ((b) and (c) of FIG. 11). When the lever 1112 is positioned at the rightmost side (or a second position) of the rail 1111 by the drag input as shown in (c) of FIG. 11, the processor 499 may change the state of the electronic device 400 from the first state to the second state by driving the state change module 440. After the state change, the processor 499 may end the display of the handler 1110.

As the state of the electronic device 400 is switched from the first state to the second state, as shown in (d) of FIG. 11, the processor 499 may extend an active area from a first display area 1121 to an entire area (the first display area 1121 and a second display area 1122) of the display 410. As the active area is extended up to the second display area 1122, the processor 499 may extend the lock screen 1130 up to the second display area 1122 and display the same. As described above, the lock screen 1130 may be different for each state of the electronic device 400 in an amount, attribute, layout, or configuration of information to be displayed to a user. Accordingly, although not shown, the processor 499 may include a preview (e.g., a preview in the form previously described with reference to FIGS. 5 to 10) in the handler 1110 and display the same on the display 410.

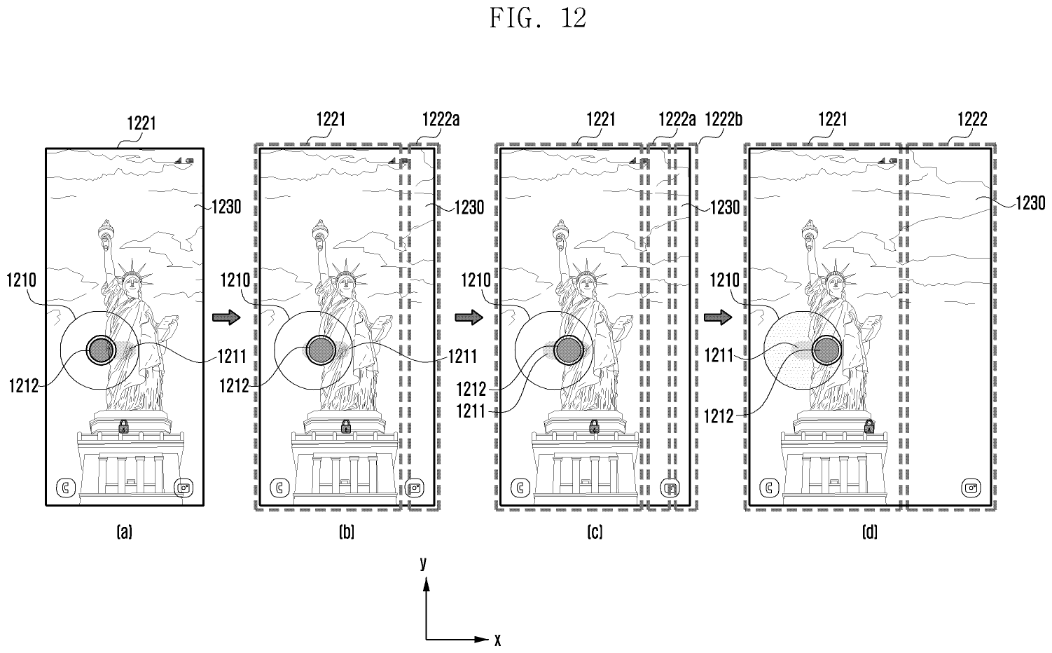

Referring to FIG. 12, when the electronic device 400 is in the first state, the processor 499 may display a lock screen 1230 in a first display area 1221 and display a handler 1210 on the lock screen 1230 as shown in (a) of FIG. 12. The processor 499 may respond to a movement of a lever 1212 on a rail 1211 in real time and drive the state change module 440 so as to unwound a part wound on the roller unit in relation to a second display area 1222 and expose the part to the outside, and extend an active area up to the exposed part. For example, the processor 499 may expose a first part 1222a ((b) of FIG. 12) of the second display area 1222 to the outside as the lever 1212 moves from the leftmost side (or a first position) of the rail 1211 to the right, and extend and display the lock screen 1230 up to the first part 1222a. The processor 499 may expose a second part 1222b ((c) of FIG. 12) of the second display area 1222 to the outside as the lever 1212 moves further to the right, and extend and display the lock screen 1230 up to the second part 1222b. As the lever 1212 moves to the rightmost side (or a second position), the processor 499 may expose the entire second display area 1222 ((d) of FIG. 12) to the outside, and extend the lock screen 1230 up to the right end of the second display area 1222 to display the same.

Referring to FIG. 13, the processor 499 may include, in a handler 1310, a rail 1311 extending in a straight line parallel to a −y-axis direction in which the display 410 is expanded, and display the rail on a lock screen 1330. When the electronic device 400 is in the first state, the processor 499 may display a lever 1312 on the uppermost end (or a first position) of the rail 1311 as shown in (a) of FIG. 13. The processor 499 may change a state of the electronic device 400 from the first state to the second state or vice versa in response to a movement of the lever 1312. For example, the processor 499 may move the lever 1312 downward in response to a downward drag input to the lever 1312. When the lever 1312 is positioned at the lowest end (or a second position) of the rail 1311 by the drag input as shown in (b) of FIG. 13, the processor 499 may change the state of the electronic device 400 from the first state to the second state by driving the state change module 440. After the state change, the processor 499 may end the display of the handler 1310. As the state of the electronic device 400 is switched from the first state to the second state, the processor 499 may extend an active area from a first display area 1321 to an entire area (the first display area 1321 and a second display area 1322) of the display 410. As the active area is extended up to the second display area 1322, the processor 499 may extend the lock screen 1330 up to the second display area 1322 and display the same as shown in (c) of FIG. 13.

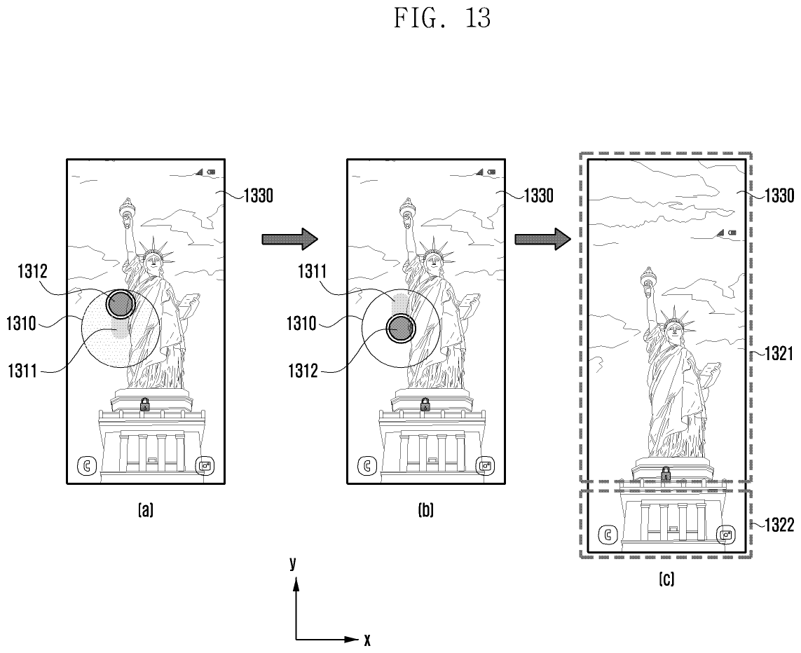

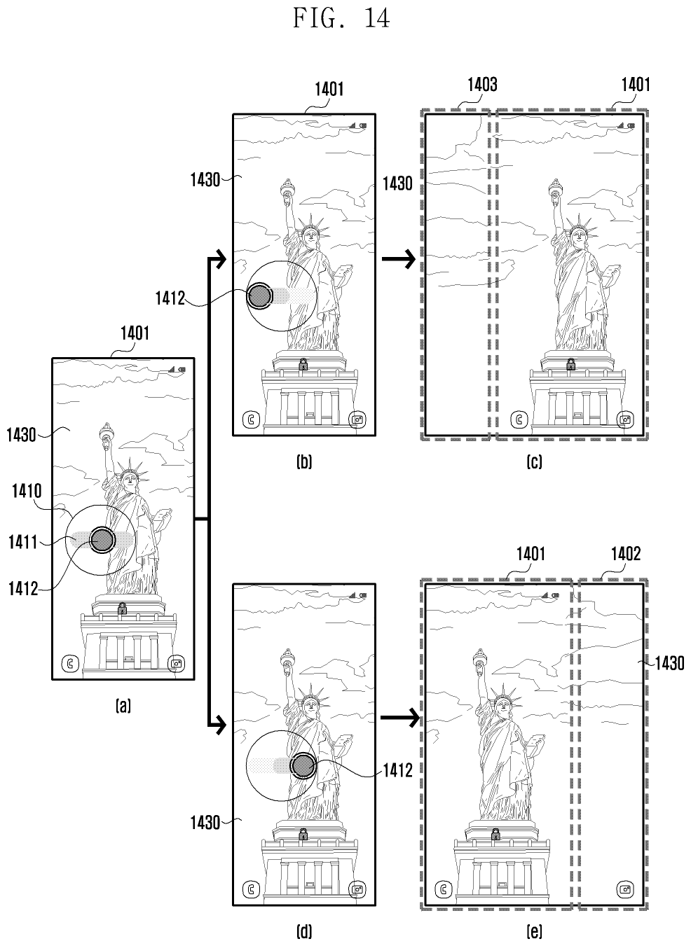

Referring to FIG. 14, in the display 410, an active area may be extended in a right direction (x-axis direction) or a left direction (−x-axis direction). For example, the display 410 may include a first display area 1401, a second display area 1402, and a third display area 1403. The second display area 1402 is a part extending from the right side of the first display area 1401, and may be wound around or unwound from a first roller unit disposed in an inner space of the electronic device 400. The third display area 1403 is a part extending from the left side of the first display area 1401, and may be wound around or unwound from a second roller unit disposed in the inner space of the electronic device 400. The state change module 440 may expose the second display area 1402 to the outside or hide the same inside by rotating the first roller unit, based on the control of the processor 499. The state change module 440 may expose the third display area 1403 to the outside or hide the same inside by rotating the second roller unit, based on the control of the processor 499.

When a state of the electronic device 400 is a first state in which the second display area 1402 and the third display area 1403 are disposed in the inner space, the processor 499 may display, on a lock screen 1430, a handler 1410 including a rail 1411 extending in a straight line parallel to an expansion direction of the display 410 as shown in (a) of FIG. 14, and a lever 1412 positioned in the center of the rail 1411 and movable to the right or left.

When the lever 1412 moves to the left and is thus positioned on the leftmost side of the rail 1411 as shown in (b) of FIG. 14, the processor 499 may drive the state change module 440 to expose the third display area 1403 to the outside, extend the lock screen 1430 up to the third display area 1403 as shown in (c) of FIG. 14, and end the display of the handler 1410.

When the lever 1412 moves to the right and is thus positioned on the rightmost side of the rail 1411 as shown in (d) of FIG. 14, the processor 499 may drive the state change module 440 to expose the second display area 1402 to the outside, extend the lock screen 1430 up to the second display area 1402 as shown in (e) of FIG. 14, and end the display of the handler 1410.

FIGS. 15, 16, 17, and 18 are diagrams illustrating certain embodiments of an operation of recalling a handler to a display.

Referring to FIG. 15, the processor 499 may receive a touch input from the display 410, recognize that the received touch input is a user input designated to recall a handler to the display 410, and display the handler on the display 410 according to the recognition. For example, the processor 499 may receive a user input indicating a long press or a force touch from the display 410 on which a home screen 1510 is displayed as shown in (a) of FIG. 15.

The processor 499 may display a handler 1520 on the home screen 1510 in response to the reception of the user input indicating the long press or the force touch from the display 410, regardless of position, and cause a lever 1521 to be positioned at a point where a long press or a force touch is generated, as shown in (b) of FIG. 15. When the handler 1520 is recalled by the user input, the processor 499 may display the lever 1521 at a rail position corresponding to a current state of the electronic device 400. For example, when the electronic device 400 is in the first state, the processor 499 may display the lever 1521 on the leftmost side of a rail 1522 as shown in (b) of FIG. 15. When the electronic device 400 is in the second state, the processor 499 may display the lever 1521 on the rightmost side of the rail 1522.

The processor 499 may move the lever 1521 to the right as shown in (c) of FIG. 15 according to a right drag input to the lever 1521. The processor 499 may move the lever 1521 to the leftmost side of the rail 1522 as shown in (d) of FIG. 15 according to a left drag input to the lever 1521. The processor 499 may recognize, as extension (or reduction) cancellation, return of the lever 1521 to a position at the time of the recalling without moving up to the opposite end as described above. According to the cancellation of the extension, the processor 499 may end the display of the handler 1520 as shown in (e) of FIG. 15. The processor 499 may perform another operation other than ending the display of the handler 1520 as an additional response according to the cancellation of the extension. For example, before the handler 1520 is recalled, as a UI element, for example, an application icon 1530 may be positioned at a point where a long press or a force touch is generated. As an additional response according to the cancellation of the extension, the processor 499 may display a pop-up window for performing a function (e.g., deletion of installation of a corresponding application or removal of the icon 1530 from the home screen 1510) connected to the icon 1530.

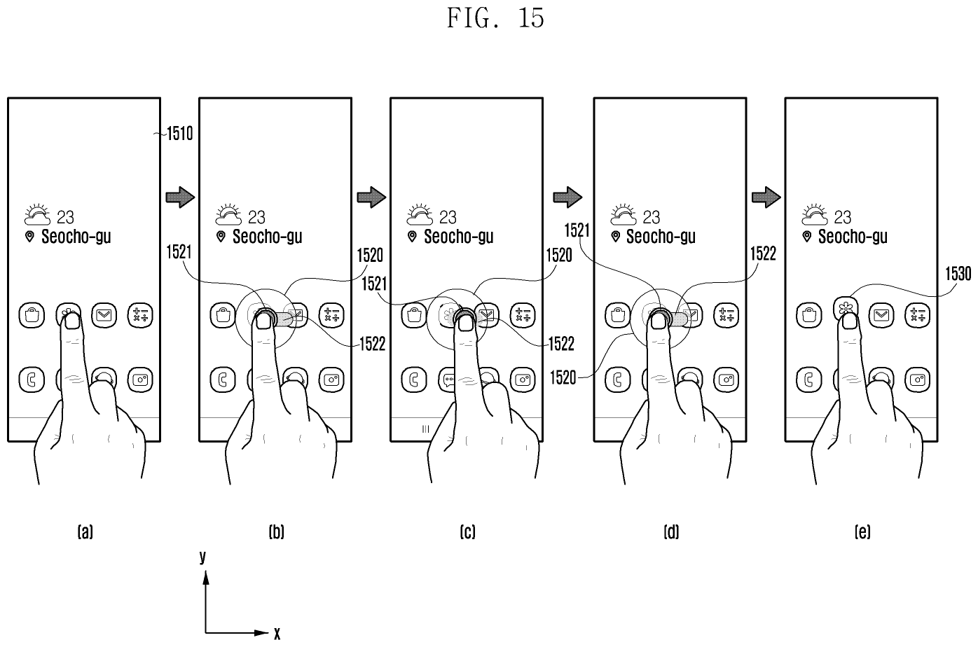

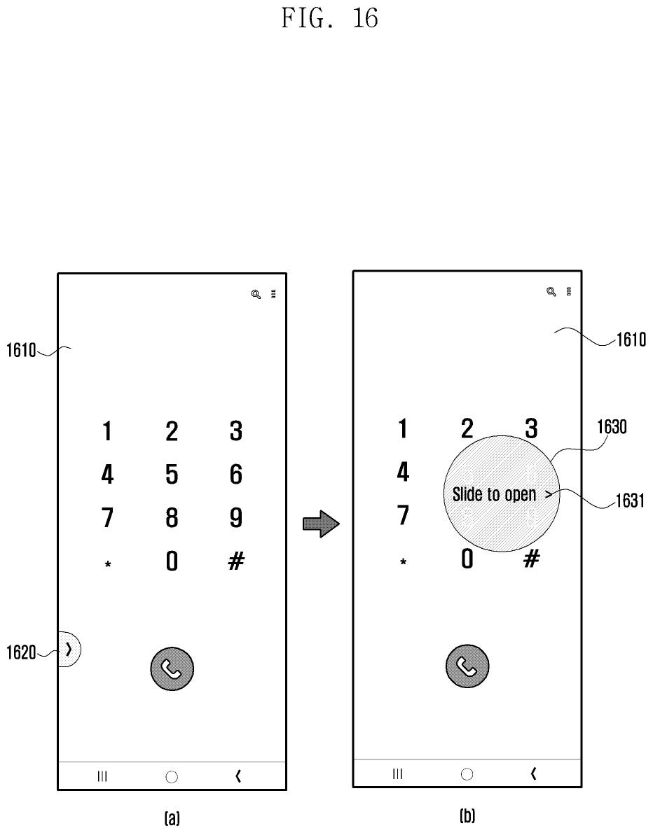

Referring to FIG. 16, the processor 499 may display an execution screen 1610 of a call application on the display 410. The processor 499 may display a button 1620 ((a) of FIG. 16) for recalling a handler on an edge of the execution screen 1610. The processor 499 may display a handler 1630 ((b) of FIG. 16) instead of the button 1620 in response to a touch input on the button 1620. For example, the processor 499 may display, on the execution screen 1610, the handler 1630 including text (e.g., slide to open) indicating that the display 410 can be expanded and a direction indicator 1631 indicating an expansion direction thereof.

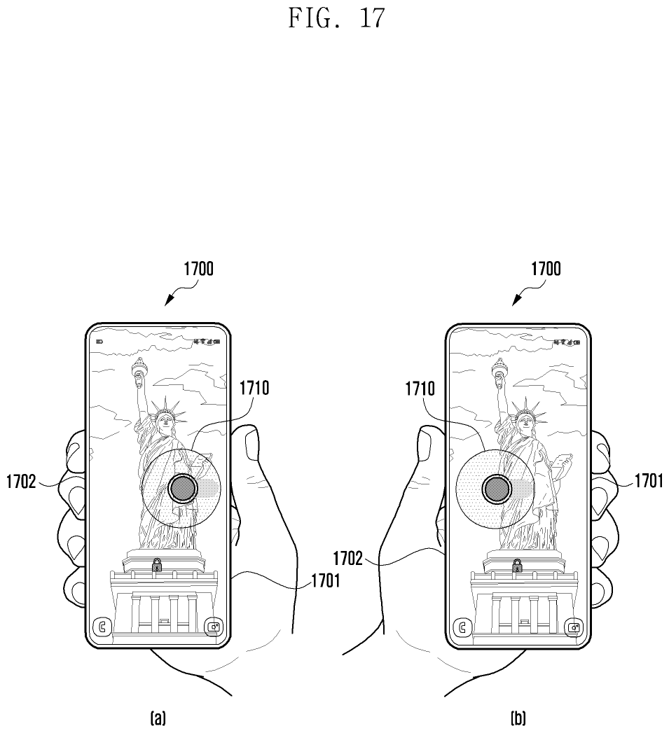

Referring to FIG. 17, the processor 499 may recognize a one-hand grip gesture in which a user grips a portable electronic device 1700 by using one hand, and accordingly, display a handler 1710 on the display 410, based on data (e.g., data representing the amount of change in capacitance) received from a sensor (e.g., a grip sensor). The processor 499 may determine a position where the handler 1710 is to be displayed according to the hand holding the portable electronic device 1700. For example, the processor 499 may receive, from the sensor, data indicating the amount of change in capacitance at a right lateral surface 1701 of the portable electronic device 1700 and the amount of change in capacitance at a left lateral surface 1702, and determine the hand holding the portable electronic device 1700 as the right hand or the left hand, based on the received data. In the case of a right hand grip gesture as shown in (a) of FIG. 17, the processor 499 may display the handler 1710 to be adjacent to the right side of the portable electronic device 1700. In the case of a left hand grip gesture as shown in (b) of FIG. 17, the processor 499 may display the handler 1710 to be adjacent to the left side of the portable electronic device 1700.

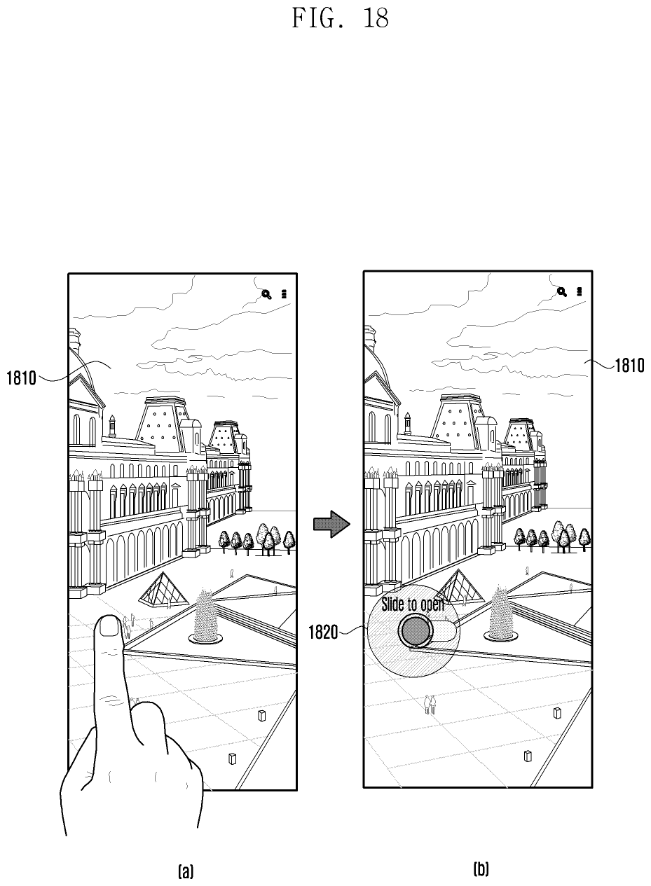

The processor 499 may receive a touch input from the display 410 on which an image 1810 is displayed as shown in (a) of FIG. 18. The processor 499 may recognize that the received touch input is a user input indicating a long press or a force touch designated for recalling a handler. The processor 499 may identify whether a UI element exists at a point where a long press or a force touch is generated. When it is identified that an UI element (e.g., an icon or a menu) operatively connected to the point do not exist at the point where the long press or force touch is generated, the processor 499 may display a handler 1820 on the image 1810 as shown in (b) of FIG. 18.

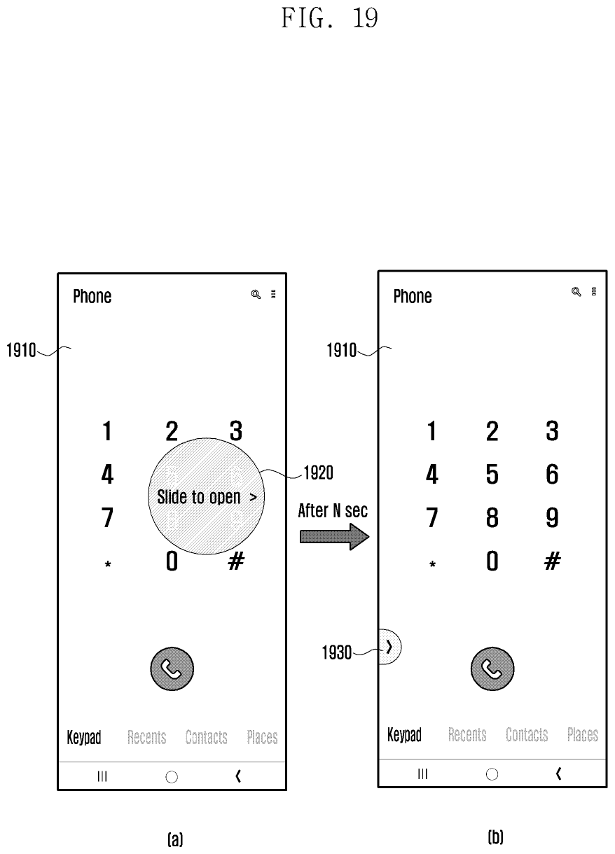

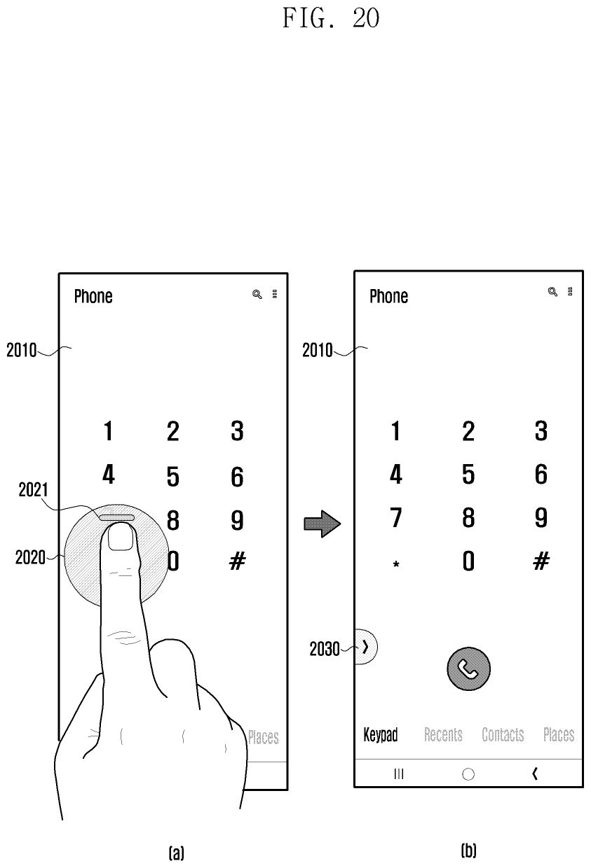

FIGS. 19 and 20 are diagrams illustrating certain embodiments of an operation of ending the display of a handler.

Referring to FIG. 19, the processor 499 may end the display of a handler when a specified time has elapsed from the time when the handler is recalled to the display 410. For example, the processor 499 may display a handler 1920 on an execution screen 1910 of a call application as shown in (a) of FIG. 19. When a specified time has elapsed from the time when the display of the handler 1920 is started, the processor 499 may end the display of the handler 1920 and display a button 1930 for recalling the handler on an edge of the execution screen 1910 as shown in (b) of FIG. 19.

Referring to FIG. 20, the processor 499 may end the display of the handler, based on a user's touch input on the handler. For example, the processor 499 may display a handler 2020 on an execution screen 2010 of a call application as shown in (a) of FIG. 20, but include, in the handler 2020, a bar 2021 for moving the handler 2020 on a screen displayed on the display 410 and display the same on the display 410. The processor 499 may move the handler 2020 on the execution screen 2010 according to a user's drag input to the bar 2021. When the handler 2020 moves up to an edge of the execution screen 2010, the processor 499 may end the display of the handler 2020 and display a button 2030 for recalling the handler as shown in (b) of FIG. 20 near the edge reached by the handler 2020.

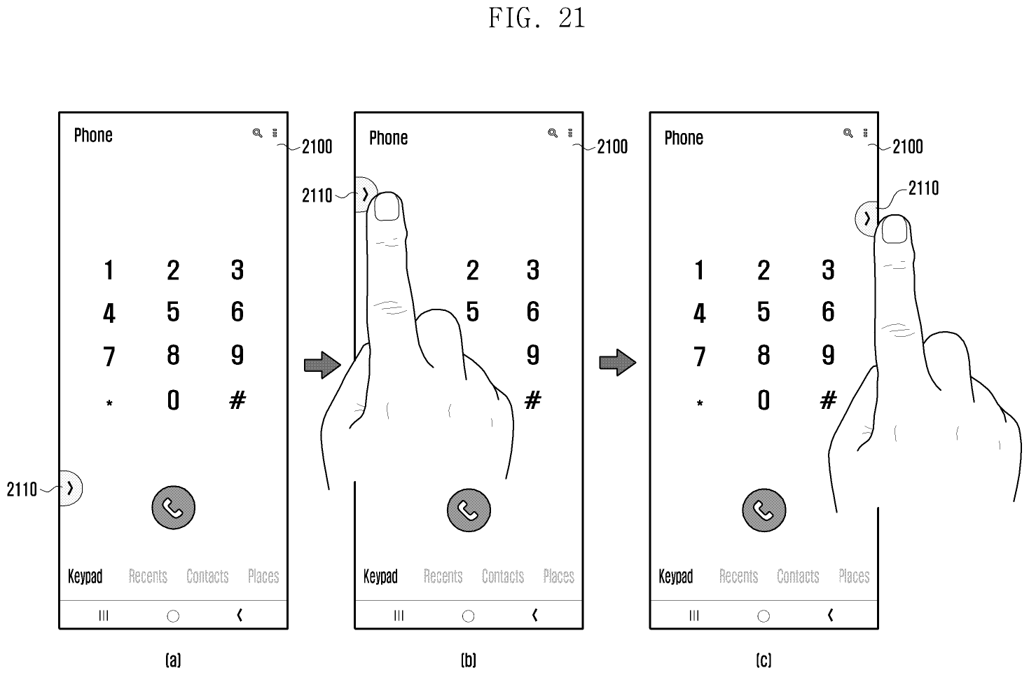

FIG. 21 is a diagram illustrating an operation of moving, on a screen, a button for recalling a handler. Referring to (a) of FIG. 21, the processor 499 may display a button 2110 on the lower left of an execution screen 2100 of a call application. Referring to (a) and (b) of FIG. 21, the processor 499 may move the button 2110 from the lower left to the upper left according to a user's drag gesture moving along the left edge. Referring to (b) and (c) of FIG. 21, the processor 499 may move and display the button 2110 from the left to right according to a user's drag gesture moving from the left edge to the right edge across the center of the screen.

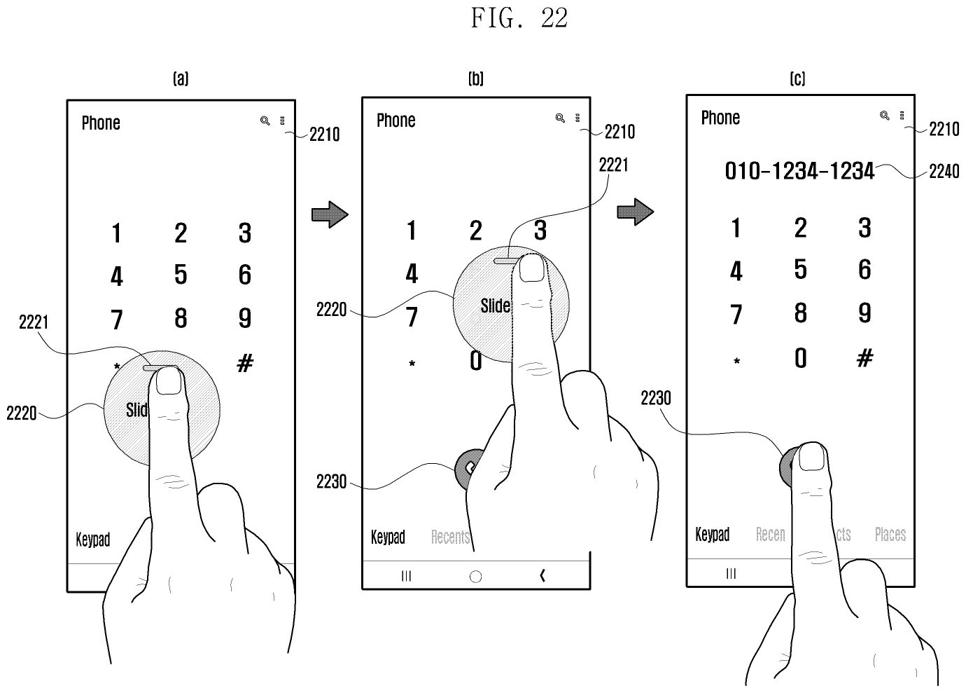

FIG. 22 is a diagram illustrating an operation of moving a handler on a screen. Referring to (a) of FIG. 22, the processor 499 may display a handler 2220 including a bar 2221 on an execution screen 2210 of a call application. The processor 499 may configure the handler 2220 to be displayed on the top layer among several layers. Accordingly, when a UI element of the execution screen 2210, for example, a call button overlaps the handler 2220, the call button may not be visually exposed. When the UI element of the execution screen 2210 overlaps the handler 2220, the processor 499 may configure an element responding to a touch input as the handler 2220. Referring to (b) of FIG. 22, the processor 499 may visually expose a call button 2230 by moving the handler 2220 on the execution screen 2210 according to a user's drag input to the bar 2221. Referring to (c) of FIG. 22, the processor 499 may receive a user's touch input on the call button 2230. The processor 499 may perform a function connected to the call button 2230 in response to the touch input on the call button 2230. For example, the processor 499 may display, on the execution screen 2210, a phone number 2240 of the most recently called contact in a call list.

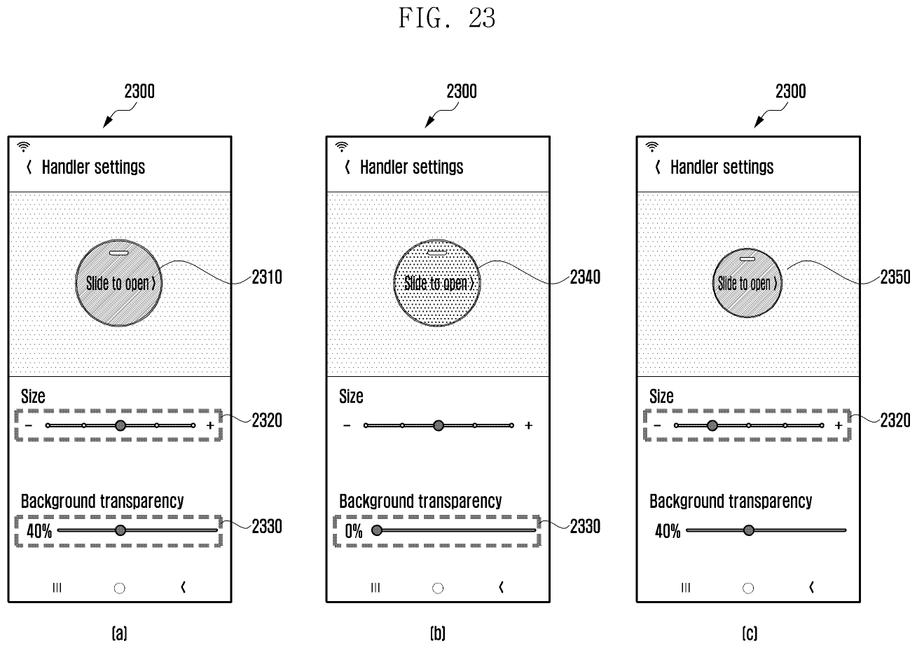

FIG. 23 is a diagram illustrating an operation of configuring attributes of a handler. The processor 499 may display, on the display 410, an execution screen 2300 for handler configuration, the execution screen including a first image 2310 indicating a handler, a size adjustment bar 2320, and a transparency adjustment bar 2330 as shown in (a) of FIG. 23. The processor 499 may adjust the transparency of a handler background in response to a user's touch input on the transparency adjustment bar 2330. For example, the processor 499 may configure the transparency of the handler background to be 0% as shown in (b) of FIG. 23 according to the touch input on the transparency adjustment bar 2330, and display a second image 2340 indicating the handler configured to have 0% transparency. The processor 499 may stepwise adjust the size of the handler in response to a user's drag input to the size adjustment bar 2320. For example, the processor 499 may display the size adjustment bar 2320 indicating that the size of the handler can be configured in one of five stages from the minimum size (first stage) to the maximum size (fifth stage). The processor 499 may configure the size of the handler in a second stage as shown in (c) of FIG. 23 according to a touch input on the size adjustment bar 2320, and display a third image 2350 indicating the handler having a configured size.

A portable electronic device (e.g., the electronic device 400 of FIG. 4) according to certain embodiments may include: a slidable housing including a first housing and a second housing coupled to the first housing to be slidable with respect to the first housing; a roller unit; a flexible display including a first display area disposed adjacent to the first housing and a second display area disposed in an inner space of the portable electronic device while surrounding the roller unit; a processor connected to the display; and a memory connected to the processor, wherein the memory stores instructions which, when executed, cause the processor to: when a state of the portable electronic device is a first state in which the second display area is disposed in the inner space, determine the first display area as an active area in which visual information is to be displayed, when the state of the portable electronic device is a second state in which the second display area is exposed to the outside, determine, as the active area, an entire area of the display including the first display area and the second display area, display first visual information and a first preview in the active area when the portable electronic device is in the first state, and display second visual information in the active area when the portable electronic device is in the second state. The first preview may be a graphic element for identifying the second visual information.

The instructions may cause the processor to: display, as the first preview, an icon indicating the difference between the first visual information and the second visual information.

The first visual information and the second visual information include a background element and a user interface (UI) element operatively connected to a specific function, and the instructions may cause the processor to: indicate, by the icon, that a layout of the user interface (UI) element is different between the first visual information and the second visual information.

The instructions may cause the processor to: indicate, by the icon, that the amount of content is different between the first visual information and the second visual information.

The first visual information and the second visual information include a background element and a user interface (UI) element operatively connected to a specific function, and the instructions may cause the processor to: indicate, by the icon, that at least one attribute of the background element and the UI element is different between the first visual information and the second visual information. The attribute may include size, color, or brightness.

The instructions may cause the processor to: indicate, by the icon, that a configuration of a UI (user interface) element operatively connected to a specific function is different between the first visual information and the second visual information.

The instructions may cause the processor to: display, in the active area, a second preview for identifying the first visual information, with the second visual information when the portable electronic device is in the second state.

The instructions may cause the processor to: notify a user that visual information is changed according to a state change of the portable electronic device, by using a tactile means and/or an auditory means.

The instructions may cause the processor to: recognize that an execution screen of an application is divided into a first execution screen as the first visual information and a second execution screen as the second visual information, based on a file used to execute the application, and in response to a user input for executing the application, display, in the active area, a preview indicating the second execution screen, together with the first execution screen when the portable electronic device is in the first state.

The instructions may cause the processor to: recognize that an execution screen of an application is divided into a first execution screen as the first visual information and a second execution screen as the second visual information, based on a file used to execute the application, and display, in the active area, a preview indicating the second execution screen while the state of the portable electronic device is changed from the first state to the second state as shown in FIG. 9.

A portable electronic device (e.g., the electronic device 400 of FIG. 4) according to certain embodiments may include: a slidable housing including a first housing and a second housing coupled to the first housing to be slidable with respect to the first housing; a roller unit; a flexible display including a first display area disposed adjacent to the first housing and a second display area disposed in an inner space of the portable electronic device while surrounding the roller unit, and configured to respond to a user input; a state change module configured to change a state of the portable electronic device from a first state in which the second display area is disposed in the inner space to a second state in which the second display area is exposed to the outside, or change the state of the portable electronic device from the second state to the first state; a processor connected to the display and the state change module; and a memory connected to the processor, wherein the memory stores instructions which, when executed, cause the processor to: when the portable electronic device is in the first state, determine the first display area as an active area in which visual information is to be displayed, when the portable electronic device is in the second state, determine an entire area of the display including the first display area and the second display area as the active area, display a handler in the active area, receive, on the handler, a user input from the display, and drive the state change module according to the user input so as to change the state of the portable electronic device from the first state to the second state or vice versa.

The instructions may cause the processor to: display, according to the user input, a lever configured to move in parallel with a direction in which the active area is extended from the first display area to the entire area of the display such that the lever is included in the handler, and change the state of the portable electronic device in response to a movement of the lever.

The instructions may cause the processor to: change the state of the portable electronic device from the first state to the second state or vice versa, in response to the movement of the lever from a first position to a second position on the handler.

The instructions may cause the processor to: end the display of the handler in response to return of the lever to the first position without moving from the first position up to the second position.

The instructions may cause the processor to: drive the state change module in response to the movement of the lever on the handler in real time, so as to unwind a part wound on the roller unit in relation to the second display area and expose the part to the outside, and extend the active area up to the exposed part.

The instructions may cause the processor to: display the handler on the display, based on the user input received from the display being a user input designated to recall the handler to the display.

The instructions may cause the processor to: display, on an edge of an execution screen of an application, a button configured to recall the handler to the display, and display the handler on the execution screen in response to a user input to the button.

The instructions may cause the processor to: recognize, based on data received from a sensor of the portable electronic device, a one-hand grip gesture in which a user grips the portable electronic device by using one hand, and display the handler in response to the one-hand grip gesture.

The instructions may cause the processor to: end the display of the handler when a specified time has elapsed from the time when the handler is recalled to the display, or when the handler moves up to an edge of an application execution screen.

The instructions may cause the processor to: display a preview indicating that the visual information to be displayed in the active area is changed at a time of changing from the first state to the second state or vice versa such that the preview is included in the handler.

The embodiments of the disclosure disclosed in the specification and the drawings are only particular examples proposed in order to easily describe the technical matters according to the embodiments of the disclosure and help with comprehension of the embodiments of the disclosure, and do not limit the scope of the embodiments of the disclosure. Therefore, the scope of certain embodiments of the disclosure should be interpreted to include all changes or modified forms derived based on the technical idea of the certain embodiments of the disclosure in addition to the embodiments disclosed herein.

1. A portable electronic device comprising:
a slidable housing comprising a first housing and a second housing coupled to the first housing to be slidable with respect to the first housing;
a flexible display comprising a first display area disposed adjacent to the first housing and a second display area disposed in an inner space of the portable electronic device;
a processor connected to the display; and
a memory connected to the processor,
wherein the memory stores instructions which, when executed, cause the processor to:
when a state of the portable electronic device is a first state in which the second display area is disposed in the inner space, determine the first display area as an active area in which visual information is to be displayed,
when the state of the portable electronic device is a second state in which the second display area is exposed to the outside as the second housing slides, determine, as the active area, an entire area of the display comprising the first display area and the second display area,
when the portable electronic device is in the first state, display first visual information and a first preview in the active area, and
when the portable electronic device is in the second state, display second visual information in the active area, and
wherein the first preview is a graphic element for identifying the second visual information.

2. The portable electronic device of claim 1, wherein the instructions cause the processor to: display, as the first preview, an icon indicating a difference between the first visual information and the second visual information.

3. The portable electronic device of claim 2, wherein the first visual information and the second visual information comprise a background element and a user interface (UI) element operatively connected to a specific function, and
wherein the instructions cause the processor to: indicate, by the icon, that a layout of the user interface (UI) element is different between the first visual information and the second visual information.

4. The portable electronic device of claim 2, wherein the instructions cause the processor to: indicate, by the icon, that an amount of content is different between the first visual information and the second visual information.

5. The portable electronic device of claim 2, wherein the first visual information and the second visual information comprise a background element and a user interface (UI) element operatively connected to a specific function,
wherein the instructions cause the processor to: indicate, by the icon, that at least one attribute of the background element and the UI element is different between the first visual information and the second visual information, and
wherein the attribute comprises size, color, or brightness.

6. The portable electronic device of claim 2, wherein the instructions cause the processor to: indicate, by the icon, that a configuration of a UI (user interface) element operatively connected to a specific function is different between the first visual information and the second visual information.

7. The portable electronic device of claim 1, wherein the instructions cause the processor to: display, in the active area, a second preview for identifying the first visual information, with the second visual information when the portable electronic device is in the second state.

8. The portable electronic device of claim 1, wherein the instructions cause the processor to: notify a user that visual information is changed according to a state change of the portable electronic device, by using a tactile means and/or an auditory means.

9. The portable electronic device of claim 1, wherein the instructions cause the processor to:
recognize that an execution screen of an application is divided into a first execution screen as the first visual information and a second execution screen as the second visual information, based on a file used to execute the application, and
in response to a user input for executing the application, when the portable electronic device is in the first state, display, in the active area, a preview indicating the second execution screen, together with the first execution screen.

10. The portable electronic device of claim 1, wherein the instructions cause the processor to:
recognize that an execution screen of an application is divided into a first execution screen as the first visual information and a second execution screen as the second visual information, based on a file used to execute the application, and
display, in the active area, a preview indicating the second execution screen while the state of the portable electronic device is changed from the first state to the second state.

11. A portable electronic device comprising:
a slidable housing comprising a first housing and a second housing coupled to the first housing to be slidable with respect to the first housing;
a flexible display comprising a first display area disposed adjacent to the first housing and a second display area disposed in an inner space of the portable electronic device, and configured to respond to a user input;
a state change module configured to change a state of the portable electronic device from a first state in which the second display area is disposed in the inner space to a second state in which the second display area is exposed to the outside as the second housing slides, or change the state of the portable electronic device from the second state to the first state;
a processor connected to the display and the state change module; and
a memory connected to the processor,
wherein the memory stores instructions which, when executed, cause the processor to:
when the portable electronic device is in the first state, determine the first display area as an active area in which visual information is to be displayed,
when the portable electronic device is in the second state, determine an entire area of the display comprising the first display area and the second display area as the active area,
display a handler in the active area,
receive, on the handler, a user input from the display, and
drive the state change module according to the user input so as to change the state of the portable electronic device from the first state to the second state or vice versa.

12. The portable electronic device of claim 11, wherein the instructions cause the processor to:
display, according to the user input, a lever configured to move in parallel with a direction in which the active area is extended from the first display area to the entire area of the display such that the lever is included in the handler, and
change the state of the portable electronic device in response to a movement of the lever.

13. The portable electronic device of claim 11, wherein the instructions cause the processor to: display the handler on the display, based on the user input received from the display being a user input designated to recall the handler to the display.

14. The portable electronic device of claim 11, wherein the instructions cause the processor to:
display, on an edge of an execution screen of an application, a button configured to recall the handler to the display, and
display the handler on the execution screen in response to a user input to the button.

15. The portable electronic device of claim 11, wherein the instructions cause the processor to: end the display of the handler when a specified time has elapsed from a time when the handler is recalled to the display, or when the handler moves up to an edge of an application execution screen.
